(19) United States
(12) Patent Application Publication
(10) Pub. No.: US 2005/0087375 A1
(43) Pub. Date: Apr. 28, 2005

(54) Active stability wheel chair based on positive angle sensors

(76) Inventors: Angus Steele, Wollaston (GB); Peter J. Tasker, Bridgnorth (GB); Wayne T. Mansell, Stourbridge (GB); Philip Schreiber, Denver, CO (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/693,636

(22) Filed: Oct. 24, 2003

(51) Int. Cl. B60K 1/00

(52) U.S. Cl. 180/65.1

(57) ABSTRACT

A power wheelchair incorporates inclinometers to measure angle of pitch and angle of roll. An inclinometer signal is used as an input to a controller. The controller alters drive parameters, such as maximum acceleration, deceleration, and minimum turning radius according to the pitch angle and roll angle of the terrain upon which the wheelchair is operated.

### BACKGROUND OF INVENTION

This invention relates in general to motor vehicles and, more particularly, to motorized wheelchairs. Most particularly, this invention relates to a system for controlling the dynamic stability of motorized wheelchairs, wherein drive parameters of the wheelchair are modified based on signals from on-board tilt or roll sensors to insure dynamic stability.

Safe dynamic performance of a wheelchair is considerably influenced by the grade of incline on which the wheelchair is operated. All wheelchairs have a maximum design-safe incline on which the wheelchairs can be operated. These inclines are generally in a range between about 9 degrees and about 14 degrees. Wheelchair control parameters are typically factory set to insure proper stability of the wheelchairs under all “designed-for” terrain conditions (i.e., terrain conditions on which the wheelchair is intended to be operated). Examples of such control parameters include forward and rearward acceleration (i.e., acceleration in a straight line), forward and rearward deceleration (i.e., deceleration in a straight line) and turning acceleration and turning deceleration (i.e. centripetal acceleration and centripetal deceleration).

These parameters are established for the anticipated incline angles the wheelchair may encounter during normal operation. The parameters are set to reduce the risk that the wheelchair will tip over when accelerating, decelerating, turning, or a combination of these maneuvers, while on a reasonable incline. The control parameters have to be set to address the worst case dynamic conditions, which means the parameters are set for maximum anticipated or designed-for incline conditions. The effect of having the control parameters set for maximum incline conditions is that the wheelchair operates at a reduced or conservative dynamic performance level, even when operated below the maximum anticipated inclines, including a flat terrain, where the wheelchair is operated a majority of the time.

The control of the dynamic stability of wheelchairs has been the focus of attention in the more recent past. In accordance with one approach, rate of turn and acceleration feedback sensors are integrated in a closed loop system. The system controls the rotational speed of the motor-driven wheels to reduce the risk of spinout and tipping. The rate of turn sensors allows the wheelchair to be operated at greater speeds. When making a turn, the system applies dynamic or regenerative braking to the driven wheel outside the turn and optionally increases the speed of the front wheel inside the turn to reduce the risk of spinout. The acceleration sensors and limited circuits limit the wheelchair turn rate below a limit value, which is continuously derived. The acceleration sensors detect and measure actual accelerations to anticipate and limit deceleration of the wheelchair to a permissible rate so that the wheelchair does not tip forward. Forward and vertical accelerometers limit deceleration when going down a hill, slope, or ramp using a trigonometric algorithmic calculation to prevent forward tipping. The forward and lateral accelerometers can limit deceleration when going around a turn using a trigonometric algorithmic calculation, which are based on values in a microprocessor. The control system monitors acceleration (i.e., forward, vertical, lateral, and in a turn) and limits velocity within an acceleration envelope.

The means of determining slope using three orthogonally positioned accelerometers, as described above, is a non-robust methodology. Slope is determined by measuring the direction of gravity in relation to the wheelchair frame. This may work well when the wheelchair is stationary. However, when the wheelchair is in motion, it will experience acceleration forces that corrupt the signal of the accelerometers.

What is needed is a system for controlling the dynamic stability of motorized wheelchairs, wherein the system can operate at elevated performance levels (i.e., above conventional factory-set reduced performance levels) when the wheelchair is operated on surfaces below maximum anticipated inclines. By monitoring inclination directly, a more accurate measure of slope may be obtained in a dynamic environment. Measuring devices, such as damped inclinometers, can provide improved indication of slope in a dynamic environment, where acceleration acts on the wheelchair.

### SUMMARY OF INVENTION

The present invention is directed toward a power wheelchair that incorporates inclinometers to measure angle of pitch and angle of roll. An inclinometer signal is used as an input to a controller. The controller alters drive parameters, such as maximum acceleration, maximum deceleration, and maximum turning acceleration according to the pitch angle and roll angle of the terrain upon which the wheelchair is operated.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a top diagrammatic representation of a wheelchair with a control system according to the invention.

FIG. 2A is a side elevational diagrammatic representation of a wheelchair with a negative pitch angle.

FIG. 2B is a side elevational diagrammatic representation of a wheelchair with a positive pitch angle.

FIG. 3A is a front elevational diagrammatic representation of a wheelchair with a negative roll angle.

FIG. 3B is a front elevational diagrammatic representation of a wheelchair with a positive roll angle.

FIG. 4 is a flow chart representing an algorithm for use by the control system according to the invention.

FIG. 5 is a flow chart representing another algorithm for use by the control system according to the invention.

### DETAILED DESCRIPTION

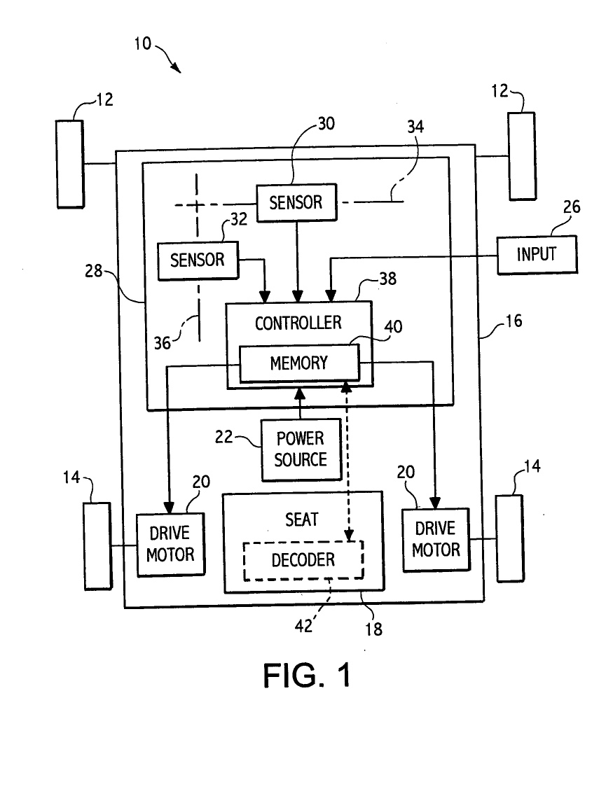

Referring now to the drawings, there is diagrammatically represented in FIG. 1 a power wheelchair 10 having casters 12 and driven wheels 14 mounted for rotation on a frame 16, which supports a seat 18, preferably an articulating seat, for carrying a wheelchair occupant. The driven wheels 14 are driven by drive motors 20, which are powered by a power source 22, such as a conventional DC battery. The driven wheels 14 may be differentially driven to steer the wheelchair 10. Alternatively, steering motors 24 may be provided for steering the driven wheels 14.

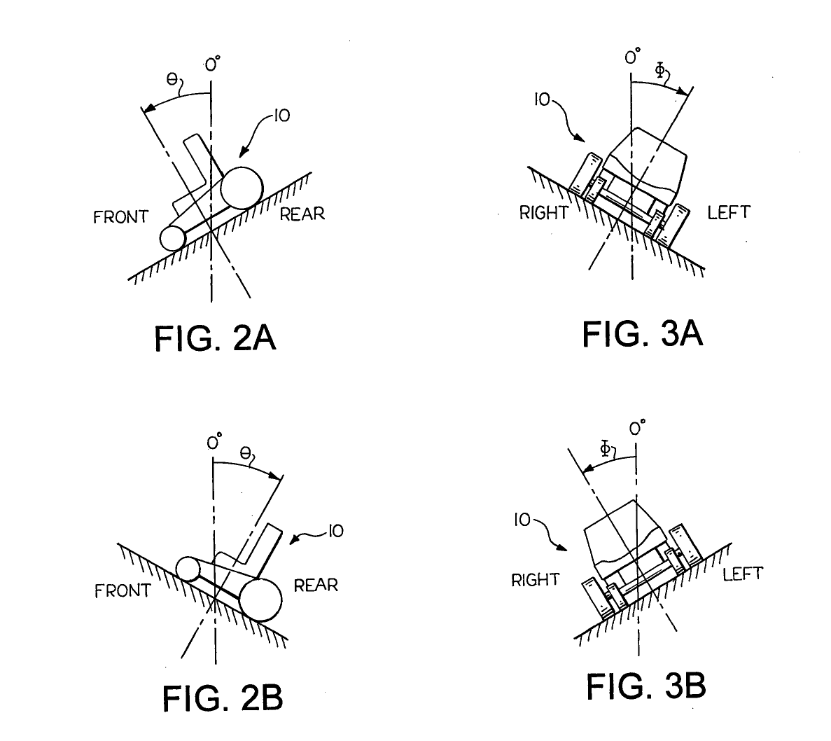

The operation of the driven wheels 14 depends on input data received from a user via an input device 26. The input device 26 provides an input signal, which corresponds to the input data, to a power wheelchair control system 28. The control system 28 includes one or more on-board devices, such as absolute angle sensors, or tilt and roll sensors, such as the inclinometers 30, 32 shown. The inclinometers 30, 32 are mounted in one or more perpendicular planes, such as the longitudinal and lateral planes 34, 36 shown, that are oriented vertically when the wheelchair 10 rests on a level surface to measure angle of pitch Θ and/or angle of roll Φ of the wheelchair 10, as diagrammatically represented in FIGS. 2A through 3B. One of the inclinometers 30, 32 measures from some negative forward pitch angle (i.e., to the left or counterclockwise when viewing FIG. 2A), through zero degrees, to some positive forward pitch angle (i.e., to the right or clockwise when viewing FIG. 2B). Similarly, the other inclinometer 30, 32 measures from some negative roll angle (i.e., to the right or clockwise when viewing FIG. 3A), through zero degrees, to some positive roll angle (i.e., to the left or counterclockwise when viewing FIG. 3B). These angles Θ, Φ are provided as sensory input data to a controller 38. The controller 38 has the ability to alter drive parameters, such as maximum acceleration, maximum deceleration, and maximum turning acceleration and turning deceleration. The turning acceleration is a function of wheelchair velocity and turning radius. Turning acceleration may be controlled by limiting the minimum turning radius and/or limiting the maximum forward or rearward velocity. Signals from the inclinometers 30, 32 are used as parameters in a control algorithm (i.e., a step-by-step procedure) and/or a look-up table, which may be accessed from on-board memory 40, which may be an integral part of the controller 38, to alter the dynamic drive characteristics of the wheelchair 10 according to the steepness and direction of the incline.

A significant performance improvement arises from this invention. A wheelchair 10 having a control system 28 according to the instant invention is not required to operate at conservative driving performance levels based on worst case dynamic conditions (i.e., maximum design-safe incline). The acceleration, deceleration, and turning acceleration and turning deceleration can operate at elevated levels when the wheelchair is operated below maximum anticipated inclines, including a flat terrain, and at more conservative levels when the inclinometers sense an incline. The steepness of the incline can determine the level of performance.

The control system 28 can be set up to default to the more conservative driving performance levels unless the inclinometers 30, 32 indicate that the wheelchair 10 is operated on a flat terrain or inclines below maximum anticipated incline. This provides additional protection in the event that one or more of the inclinometers 30, 32 fails, or if the controller 38 receives no signal from the inclinometers 30, 32. The control system 28 only decreases performance limits (i.e., permits operation under elevated performance levels) when on flat terrain or inclines below maximum anticipated inclines.

The wheelchair 10 according to the instant invention may incorporate the ability to move and support the wheelchair occupant in various positions. This includes the ability to move the wheelchair occupant to a tilted, reclined, lifted, or standing position. When the wheelchair occupant is supported in any of these positions, the wheelchair 10 may become less stable than when supporting the wheelchair occupant in a normal seated position. If the wheelchair 10 is on an incline of sufficient steepness, the wheelchair 10 could tip over when moving the wheelchair occupant from a normal seated position to a tilted, reclined, lifted, or standing position. Incorporating inclinometers on board makes it possible for the controller 38 to prohibit or limit motion to these positions if the controller 38 receives an indication from an inclinometer 12, 14 that the wheelchair 10 is resting on an incline.

The algorithm and/or look up table could be employed to alter the operating performance of the wheelchair 10 based on a combination of factors, such as the position (e.g. tilt angle, recline angle, and the like) of the wheelchair occupant and the inclination of the terrain (i.e., the pitch and/or roll angles Θ, Φ of the wheelchair 10), as measured by the inclinometers 30, 32. This would add an additional level of safety from the wheelchair 10 tipping or rolling over to further account for the stability of the wheelchair 10 under the various positions in combination with the pitch or roll angles Θ, Φ of the wheelchair 10.

In operation, performance characteristics based on signals from inclinometers 30, 32 could be modified, for example, by reducing maximum forward deceleration, maximum rearward acceleration, and maximum turning acceleration and maximum turning deceleration when the wheelchair 10 is on a steep downward incline (i.e., a negative forward pitch). On a steep upward incline, (i.e., a positive forward pitch), the control system 28 could reduce maximum forward acceleration, and maximum rearward deceleration. On steep inclines downward toward the left (i.e., a negative roll angle to the left), the control system 28 could reduce maximum turning acceleration towards the right. Turing acceleration towards the left could remain unaffected. On steep inclines downwards toward the right, (i.e. a negative roll angle to the right), the control system 28 could reduce maximum turning acceleration towards the left. Turning acceleration towards the right could remain unaffected.

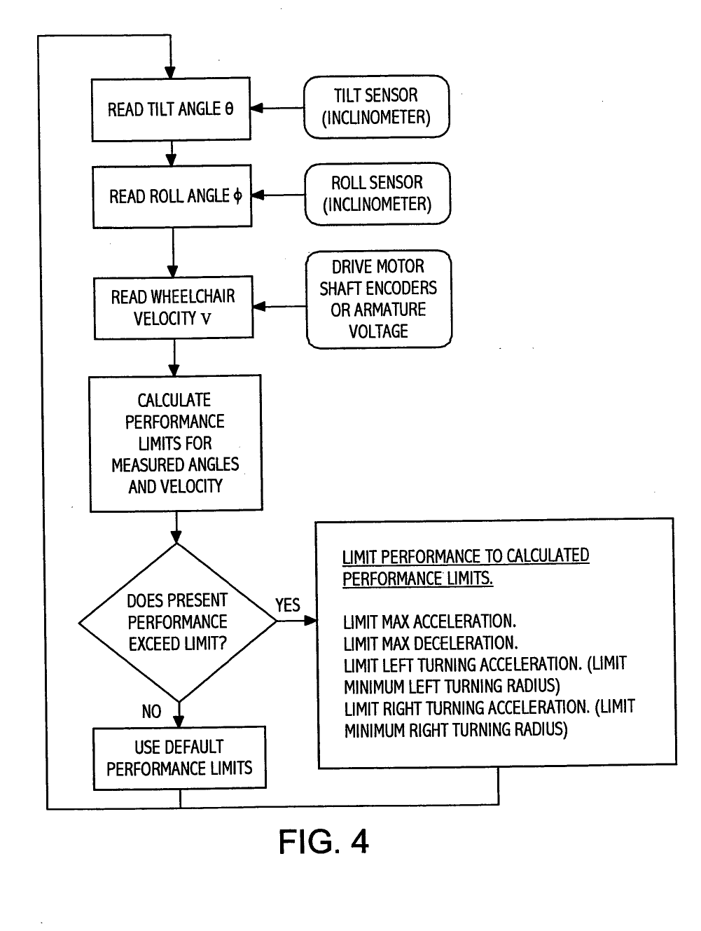

An example of an algorithm adapted for use by the control system 28 is provided in FIG. 4. In accordance with this algorithm, the controller 38 senses angle of pitch Θ, angle of roll Φ, wheelchair velocity V, and possibly, the seat recline angle Y. This is accomplished by sensing the pitch and roll angles Θ, Φ in the form of inputs from the inclinometers 30, 32 (i.e., tilt and roll sensors). The wheelchair velocity V can be estimated or sensed by the controller 38 from the drive motors 20. The seat recline angle Y can be sensed by the controller 38 from a recline actuator decoder 42, potentiometer, or other sensor (schematically represented in FIG. 1), which is well known in the art of the invention.

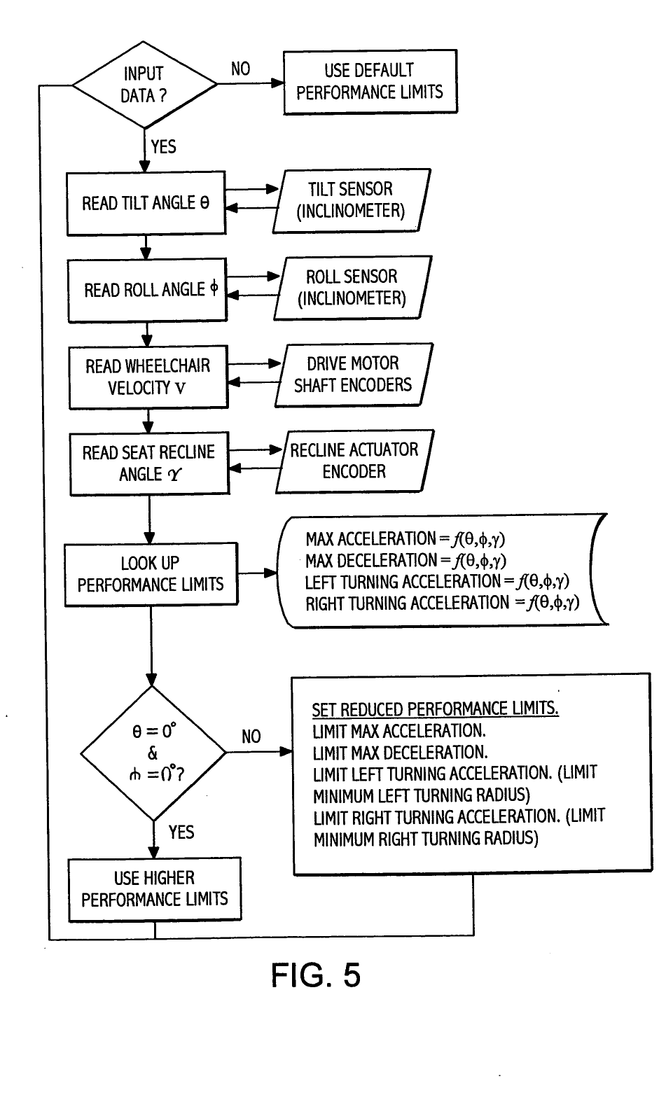

Another example of an algorithm adapted for use by the control system 28 is provided in FIG. 5. Similar to the previous algorithm, the controller 38 according to this algorithm senses angle of pitch Θ, angle of roll Φ, and wheelchair velocity V. This is accomplished by sensing the pitch and roll angles Θ, Φ in the form of inputs from the inclinometers 30, 32 (i.e., tilt and roll sensors). The wheelchair velocity V can be sensed by the controller 38 from the drive motors 20. The controller 38 then calculates performance limits for the sensed angles Θ, Φ and velocity V. If the controller 38 then determines if the present performance of the wheelchair 10 exceeds the calculated performance limits. If the present performance of the wheelchair 10 do not exceed the calculated performance limits, then higher performance values are used as control parameters for controlling the acceleration, deceleration, turning acceleration, and turning deceleration of the wheelchair 10. If the present performance of the wheelchair 10 exceeds the calculated performance limits, than the maximum acceleration, deceleration, or left or right turning acceleration or deceleration, or alternatively, the left and right turning radii, are limited to acceptable safe values.

It should be appreciated by one of ordinary skill in the art that the electronic control system 24 according to the present invention is a hybrid closed and open loop system. That is to say, the electronic control system 24 monitors the velocity of the wheelchair, for example, by the speed encoders, on a substantially continuous basis. In this regard, the electronic control system 24 functions as a closed loop system. However, the electronic control system 24 periodically senses the angle of incline of the supporting surface (i.e., via input from the inclinometers 30, 32) and depending on the angle of incline, allows the wheelchair 10 to be operated within certain control parameters. The control parameters change only when a change in the angle of incline dictates a change. In this way, the electronic control system 24 functions as an open loop system.

There are a number of advantages of the invention. For example, the wheelchair 10 will have enhanced dynamic operating performance under normal operating conditions (e.g., when operated on flat terrain). The wheelchair 10 will also operate within safe performance limits to prevent rolling or tipping over when operated on inclined terrain. Moreover, the wheelchair 10 can prohibit action to move the wheelchair occupant to tilted, reclined, lifted, or standing positions when an inclinometer 30, 32 indicates that the wheelchair 10 is resting on a sufficiently steep incline.

The hybrid closed and open loop system, described above, eliminates the need for complex feedback control typically required of a conventional closed loop control system. Dynamic stability characteristics of the wheelchair 12 are determined in advance through experimental testing on various inclines, under different driving conditions, in order to establish safe limits. These limits are stored in the on-board memory 40 and accessed, either as a control algorithm or look-up table. The resulting electronic control system 24 is considerably simpler, more reliable, and less expensive than a closed loop system.

The principle and mode of operation of this invention have been explained and illustrated in its preferred embodiment. However, it must be understood that this invention may be practiced otherwise than as specifically explained and illustrated without departing from its spirit or scope.

1. A wheelchair comprising:
one or more devices for sensing an angle of a surface on which the wheelchair is supported;
a controller receiving input from the one or more devices, wherein the input corresponds to an angle of a surface on which the wheelchair is supported; and
at least one of either a control algorithm or look up table used by the controller to control drive parameters of the wheelchair according to the input from the one or more devices.

2. The wheelchair of claim 1, wherein the one or more devices are absolute angle sensors.

3. The wheelchair of claim 1, wherein the one or more devices are on-board inclinometers.

4. The wheelchair of claim 1, wherein the algorithm is a mathematical control algorithm.

5. The wheelchair of claim 1, wherein the drive parameters controlled by the controller include one or more of wheelchair acceleration, wheelchair deceleration, turning acceleration or deceleration and turning deceleration, velocity, or turning radius.

6. The wheelchair of claim 1, wherein the drive parameters controlled by the controller include one or more of maximum wheelchair acceleration, maximum wheelchair deceleration, maximum turning acceleration or deceleration, maximum velocity, or minimum turning radius.

7. A wheelchair comprising:
one or more devices for sensing at least one of a pitch angle or a roll angle of a surface on which the wheelchair is supported;
a controller receiving input from the one or more devices, wherein the controller prevents the wheelchair from changing to a less stable configuration when the controller senses an input from at least one of the one or more device indicating that the wheelchair is on a supporting surface with sufficient incline.

8. The wheelchair of claim 7, wherein the controller prevents the wheelchair from changing from a configuration supporting a wheelchair occupant in a seated position to a configuration supporting a wheelchair in one of a reclined, tilted, lifted, or standing position when the controller senses an input from at least one of the one or more device indicating that the wheelchair is on a supporting surface with sufficient incline.

9. The wheelchair of claim 7, wherein the one or more devices are on-board absolute angle sensors.

10. The wheelchair of claim 7, wherein the one or more devices are on-board inclinometers.

11. A wheelchair comprising:
a frame;
one or more drive wheels supporting the frame relative to a supporting surface;
one or more drive motors for driving the one or more drive wheels;
one or more devices for sensing the angle of the supporting surface; and
a controller connected to the one or more sensing devices for receiving input data from the one or more sensing devices corresponding to the angle of the supporting surface, wherein the controller controls drive parameters of the one or more drive motors according to a combination of input data including the input data from the sensing devices and input data from the one or more drive motors corresponding to the velocity of the drive motors, and wherein the drive parameters controlled by the controller include one or more of wheelchair acceleration, deceleration, turning acceleration or deceleration, velocity, or turning radius.

12. The wheelchair of claim 11, wherein the wheelchair is adapted to be configured to various configurations and the controller prevents the wheelchair from changing to a less stable one of the configurations when the controller senses an input from at least one of the one or more devices indicating that the wheelchair is on a supporting surface with sufficient incline.

13. The wheelchair of claim 11, wherein the wheelchair is adapted to be configured to various configurations and the controller prevents the wheelchair from changing from a configuration supporting a wheelchair occupant in a seated position to a configuration supporting a wheelchair in one of a reclined, tilted, lifted, or standing position when the controller senses an input from at least one of the one or more device indicating that the wheelchair is on a supporting surface with sufficient incline.

14. The wheelchair of claim 11, further comprising an articulating seat, the controller receiving input data from the articulating seat corresponding to the position of the seat and further controlling the articulating seat according to the combination of input data and the input data from the articulating seat.

15. The wheelchair of claim 14, wherein the articulating seat has a recline actuator decoder and the input data from the articulating seat is sensed by the controller from a recline actuator decoder.

16. The wheelchair of claim 11, further comprising one or more steering motors at least one of the one or more drive wheels, the controller further controling parameters of the one or more steering motors according to the combination of input data.
